(19) United States
(12) Patent Application Publication
(10) Pub. No.: US 2026/0237731 A1
(43) Pub. Date: Aug. 13, 2026

(54) Solid electrolyte with improved dendrite resistance

(71) Applicant: SCHOTT AG, Mainz (DE)

(72) Inventors: Sebastian Leukel, Mainz (DE); Nina Tong Hoinkis, Mainz (DE); Jörg Schuhmacher, Mainz (DE); Christoph Loho, Mainz (DE); Andreas Roters, Mainz (DE); Meike Schneider, Mainz (DE)

(21) Appl. No.: 19/153,358

(22) PCT Filed: Jan. 15, 2024
(86) PCT No.: PCT/EP2024/050818

§ 371 Date: Aug. 4, 2025

(30) Foreign Application Priority Data
Feb. 7, 2023 (DE) 10 2023 102 921.5

(51) Int. Cl. H01M 10/0562; H01M 10/0525; H01M 50/434

(52) U.S. Cl. CPC H01M 10/0562; H01M 10/0525; H01M 50/434; H01M 2300/0071

(57) ABSTRACT

A solid electrolyte including a lithium ion-conducting material, wherein the lithium ion-conducting material includes a crystalline phase and an amorphous phase, wherein the crystalline phase includes a main crystal phase, wherein the main crystal phase has a proportion of the crystalline phase of at least 50% by weight, wherein the relative density of the solid electrolyte is at least 90% and wherein the solid electrolyte has a microstructure in which less than 10% of the cross-sectional area of the solid electrolyte is accounted for by grains with a diameter of more than 30 μm.

The invention relates to a solid electrolyte comprising a lithium ion-conducting material, in particular a glass ceramic, with improved dendrite stability (stability against the formation of dendrites), and to use and a method for production.

### BACKGROUND

All-solid-state batteries (ASSB), because of their high energy density and safety, are considered to be the future of energy storage technology/electromobility. The core of this innovation is the replacement of the liquid electrolyte with a solid ion-conducting separator, which also allows, inter alia, the use of Li metal as anode material if the separator itself is stable to lithium (e.g. for example in the case of use of lithium lanthanum zirconate (LLZO)). In the course of charging, however, it is possible that the Li deposited at the anode will grow into the separator up to the cathode side. This is called dendrite formation. If such a dendrite forms, this will result in a short circuit. The higher the current density in the course of charging, the easier the formation of the unwanted dendrites. Therefore, it is necessary to provide a separator material which suppresses dendrite formation even at relatively high current densities.

Solid ion-conducting separators include an ion-conducting solid, also referred to as “solid electrolyte” or “solid-state electrolyte”. In the case of solid-state batteries, lithium ion-conducting materials are used.

### SUMMARY OF THE INVENTION

In the field of solid electrolytes, a distinction is made between organic solid electrolytes (generally based on polymers) and inorganic solid electrolytes. There are also composites with organic and inorganic components. In such composites, LLZO particles are frequently embedded into a lithium ion-conducting polymer matrix. Inorganic solid electrolytes are typically used in sintered form as separators in solid-state batteries. The lithium ion-conducting material is ground, then pressed to compacts, and these are sintered at a particular sintering temperature. Alternatively, the ground lithium ion-conducting material can also be mixed with binders and solvents and processed to a green film in the “tape casting” process. This green foil is then sintered and the separator is produced in this way. The sintering results in compaction. For use as a separator, the aim is a relative density of at least 90%. One reason is that the growth of dendrites takes place predominantly in the cavities at the grain boundaries of the sintered molding.

In the case of the known inorganic solid electrolytes, comparatively high sintering temperatures are required in order to achieve sufficient compaction. However, these high sintering temperatures result in excessive grain growth. However, a high grain size is likewise associated with poor dendrite stability. It is specifically the measure that is supposed to lead to an improvement in dendrite stability that is in turn associated with a deterioration in dendrite stability.

It is an object of the invention to overcome the disadvantages from the prior art and to provide a material with improved dendrite stability.

Solid electrolytes with high relative density and low grain size can increase dendrite stability. However, high density and low grain size in sintered solid electrolytes are contradictory in that both are determined by temperature and time, but in opposite directions: High temperatures/long periods lead to high density but also promote grain growth; low temperatures/short periods prevent grain growth but do not achieve sufficiently high densities.

It would therefore be advantageous to have a material available that can be sintered to high relative density even at comparatively low temperatures and within a comparatively short time. In addition, the sintered material should have low interfacial resistance at the grain boundaries. The present invention provides such materials.

The lithium ion-conducting material may in particular be a glass ceramic. A glass ceramic within the context of the present invention is a material which is produced from a homogeneous melt of the components by cooling and spontaneous crystallization or by cooling and a subsequent controlled ceramization process. Before, during or after cooling, a shaping step or comminution process can be carried out.

According to one aspect of the present disclosure, the invention relates to a solid electrolyte comprising or consisting of a lithium ion-conducting material, wherein the lithium ion-conducting material comprises a crystalline phase and an amorphous phase, wherein the crystalline phase comprises a main crystal phase, wherein the main crystal phase has a proportion of the crystalline phase of at least 50% by weight, wherein the relative density of the solid electrolyte is at least 90% and wherein the solid electrolyte has a microstructure in which less than 10% of the cross-sectional area of the solid electrolyte is accounted for by grains with a diameter of more than 30 μm.

Such a solid electrolyte can be produced in a simple, brief sintering step at comparatively low temperatures from a lithium ion-conducting material, the amorphous phase of which has a softening point in the range of 850° C. to 1100° C. The amorphous phase can also be referred to as the residual glass phase.

The relative density of the solid electrolyte can be determined in particular as follows: He pycnometry is used to determine the density of the powder. “Density of the powder” refers to the density of the material, not the bulk density. In the case of LLZO, the density of the powder is, for example, about 5 g/cm³. After sintering, the density of the solid electrolyte is determined by weighing and geometric measurement (density=mass per unit volume). The relative density is the quotient of the density of the solid electrolyte and density of the powder.

The diameter of a grain in the cross-sectional area of the solid electrolyte is determined as the maximum Feret diameter (Feret-max), i.e. the maximum distance between two parallel tangents to the contour of the grain in the cross-sectional area of the solid electrolyte examined.

The softening point of the amorphous phase in the context of the lithium ion-conducting material is not identical to the softening point that a corresponding glass would have as such (without the crystalline phase). Therefore, the softening point of the amorphous phase has to be determined in the context of the lithium ion-conducting material. This is done in accordance with the invention by means of differential scanning calorimetry (DSC). The lithium ion-conducting material is subjected to the following DSC program: 20-100 mg of the lithium ion-conducting material are placed into a platinum DSC crucible. The measurement is conducted at a heating rate of 10 K/min under argon from room temperature to at least 1100° C. The softening point of the amorphous phase in association with the lithium ion-conducting material is also referred to as “compaction point” in the present disclosure.

An endothermic DSC signal in the range from 850° C. to 1100° C. indicates softening of the amorphous phase of the lithium ion-conducting material, in particular of the residual glass phase in the glass ceramic. If this occurs at sufficiently low temperatures (850-1100° C.), the material can be compressed and any cavities filled with the residual glass phase. If the material does not show such a DSC signal, or does so only at temperatures >1100° C., correspondingly higher sintering temperatures are necessary for compaction, but these are then accompanied by unwanted grain growth and hence reduced dendrite stability. In particular, the DSC signal can be determined with a heat-flow DSC, for example with the Pegasus® DSC 404 F1 instrument from NETZSCH-Gerätebau GmbH. The signal is a positive (endothermic) or negative (exothermic) variance from the baseline.

In order to be able to ascertain with sufficient certainty that the amorphous phase has a compaction point within a range from 850° C. to 1100° C., the endothermic DSC signal in the range from 850° C. to 1100° C. should preferably assume a value of at least 10 J/g. If the endothermic DSC signal in the range from 850° C. to 1100° C. has a size of at least 10 J/g, the amorphous phase has a compaction point within a range from 850° C. to 1100° C.

It is thus particularly important that the amorphous phase has a compaction point within a range from 850° C. to 1100° C. If the compaction point is too low, the amorphous phase is too fluid at the sintering temperature and therefore “flows” out of the compact before sintering activity sets in. If the compaction point is too high, the sintering temperatures required for compaction are too high, which is associated with unwanted grain growth and correspondingly reduced dendrite stability. The compaction point of the amorphous phase is preferably within a range from 900° C. to 1050° C.

It is also important that the proportion of the amorphous phase in the lithium ion-conducting material is large enough to ensure sufficient compaction on softening of the amorphous phase. The proportion of the amorphous phase in the lithium ion-conducting material is therefore preferably at least 0.1% by weight, more preferably at least 0.3% by weight. The proportion of the amorphous phase is preferably not more than 5.0% by weight. If the proportion of the amorphous phase is too high, Li ion conductivity decreases. For example, the proportion of the amorphous phase in the lithium ion-conducting material may be within a range from 0.1% to 5.0% by weight or from 0.3% to 5.0% by weight.

The amorphous phase preferably comprises Li₂O and at least one glass former selected from Al₂O₃, SiO₂, P₂O₅, B₂O₃ and combinations of two or more of these. The amorphous phase preferably consists of Li₂O and at least one glass former selected from Al₂O₃, SiO₂, P₂O₅, B₂O₃ and combinations of two or more of these. Li₂O is required for Li ion conductivity. The glass former stabilizes the amorphous phase. B₂O₃ is least preferred among the glass formers. Therefore, B₂O₃ is preferably only in small proportions. SiO₂ and P₂O₅ are more preferred compared to B₂O₃. The most preferred glass former is Al₂O₃. Al₂O₃ may be the sole glass former in the lithium ion-conducting material. However, one or more additional glass formers may also be provided, in particular SiO₂ and/or P₂O₅.

Since the glass former is present in the amorphous phase and not in the crystalline phase, the glass former content of the amorphous phase (based on the total mass of the lithium ion-conducting material) corresponds to the glass former content of the lithium ion-conducting material (based on the total mass of the lithium ion-conducting material). An exception here is Al₂O₃, which, if the crystalline phase has a garnet structure, especially if it is lithium lanthanum zirconate (LLZO), may also be present in the crystalline phase. However, the solubility of Al₂O₃ in a crystalline phase with a garnet structure is limited. Depending slightly on the composition and preparation process, it is about 0.1 mol of Al₂O₃ per formula unit of LLZO, i.e. Li_{6.4}Al_{0.2}La₃Zr₁₂O₁₂. This is also applicable to doped variants of this garnet that are doped with one or more divalent cations M^{II}, one or more trivalent cations M^{III}, one or more tetravalent cations M^{IV} and one or more pentavalent cations M^{V}. Therefore, in the calculation of the amorphous phase from the composition, Al₂O₃ is assigned to the crystalline phase up to an amount of 0.1 mol of Al₂O₃ per formula unit of the garnet. Excess Al₂O₃, i.e. the portion exceeding the amount of 0.1 mol of Al₂O₃ per formula unit of the garnet, is assigned to the amorphous phase.

The amorphous phase can be produced by the production process via the melt, wherein the solidifying operation, in addition to the crystalline phase (in particular crystalline LLZO), also forms the amorphous phase comprising, in particular consisting of, the excess Li₂O and the glass formers. The glass formers mentioned above do not “fit” into the crystal structure, in particular LLZO crystal structure, because of their small ionic radius. In addition, the amorphous phase can also be prepared separately, for example via a melting process, and then added to and mixed with the crystalline phase. This can be achieved, for example, by grinding of crystalline phase and amorphous phase. Other production processes and mixing processes are also conceivable.

Combination of a lithium ion-conducting crystalline phase, for example Li-stable LLZO (especially Ta- or Al-doped), with an amorphous phase can increase dendrite stability, especially in the grain boundaries of the sintered separator. The amorphous phase contains, for example, Li₂O (for Li ion conductivity) and SiO₂ (as glass former), and optionally one or more additional glass formers (especially selected from the group consisting of Al₂O₃, P₂O₅, B₂O₃ and combinations thereof).

The proportions of the crystalline phase and of the amorphous phase in the lithium ion-conducting material are determined in particular on the basis of the composition of the lithium ion-conducting material. For this purpose, the empirical formula of the crystalline phase is used and the composition is converted from % by weight to at %. Subsequently, the elements that form the crystalline phase according to the empirical formula are assigned thereto (in the case of multiple crystalline phases, the procedure is analogous). An excess of Li, O and the glass formers is assigned to the amorphous phase.

The procedure for determining the proportions of the crystalline phase and the amorphous phase is simplified when the composition in at % is normalized to one of the stoichiometric factors from the empirical formula of the crystalline phase. This is shown hereinafter by the example of the empirical formula of LLZO, Li_{7-3x+y-z}AlₓM_{y}^{II}M_{3-y}^{III}M_{2-z}^{IV}M_{z}^{V}O₁₂: First, the composition in at % is normalized to M^{II}+M^{III}=3 (or alternatively to M^{IV}+M^{V}=2) in order to determine the composition in pfu (parts per formula unit). This composition is divided into the crystal-forming components and the components that are not incorporated into the stoichiometric crystal: surplus Li and O, and also Si, P, B, Al (up to an amount of 0.2 pfu of Al, this is one of the crystal-forming components owing to limited solubility in the garnet structure. If more Al is present, the difference to 0.2 pfu is assigned to the amorphous phase). Subsequently, the amorphous phase in pfu is converted by means of the respective atomic masses back to % by weight of the oxides present. The proportion by weight of the amorphous phase in the lithium ion-conducting material is the sum total of the proportions by weight of the oxides in the amorphous phase (based on the total mass of the lithium ion-conducting material) in % by weight.

The composition of the amorphous phase can be chosen in such a way that no undesirable interaction with crystals occurs, in particular LLZO crystals (e.g. conversion to the less conductive tetragonal modification of LLZO). For instance, the cubic modification can be converted to the less conductive tetragonal modification LLZO if the Li₂O content of the amorphous phase is too high. For example, the Li₂O content of the amorphous phase may be limited to not more than 5.00% by weight, not more than 4.50% by weight, not more than 4.00% by weight, or not more than 3.50% by weight based on the total mass of the lithium ion-conducting material. The Li₂O content of the amorphous phase, based on the total mass of the lithium ion-conducting material, may, for example, be at least 0.05% by weight, at least 0.20% by weight, at least 0.40% by weight, or at least 0.60% by weight. The Li₂O content of the amorphous phase, based on the total mass of the lithium ion-conducting material, may be within a range from 0.05% to 5.00% by weight, from 0.20% to 4.50% by weight, from 0.40% to 4.00% by weight, or from 0.60% to 3.50% by weight.

The proportion of Li₂O in the lithium ion-conducting material of the invention may, for example, be at least 10.0% by weight, at least 10.5% by weight, or at least 11.0% by weight. The proportion of Li₂O in the lithium ion-conducting material of the invention may, for example, be not more than 15.0% by weight, not more than 14.5% by weight, or not more than 14.0% by weight. The proportion of Li₂O in the lithium ion-conducting material of the invention may, for example, be within a range of 10.0% to 15.0% by weight, from 10.5% to 14.5% by weight, or from 11.0% to 14.0% by weight.

The proportion of the sum total of ZrO₂ and HfO₂ in the lithium ion-conducting material of the invention may be at least 17% by weight, at least 18% by weight, or at least 19% by weight. The proportion of the sum total of ZrO₂ and HfO₂ in the lithium ion-conducting material of the invention may, for example, be not more than 35% by weight, not more than 33% by weight, or not more than 31% by weight. The proportion of the sum total of ZrO₂ and HfO₂ in the lithium ion-conducting material of the invention may, for example, be within a range of 17 to 35% by weight, from 18 to 33% by weight, or from 19 to 31% by weight.

The proportion of the sum total of Ta₂O₅, Nb₂O₅ and Al₂O₃ in the lithium ion-conducting material of the invention may be at least 0.5% by weight, at least 0.75% by weight, or at least 1% by weight. The proportion of the sum total of Ta₂O₅, Nb₂O₅ and Al₂O₃ in the lithium ion-conducting material of the invention may, for example, be not more than 15% by weight, not more than 13.5% by weight, or not more than 12% by weight. The proportion of the sum total of Ta₂O₅, Nb₂O₅ and Al₂O₃ in the lithium ion-conducting material of the invention may, for example, be within a range of 0.5 to 15% by weight, from 0.75 to 13.5% by weight, or from 1 to 12% by weight.

SiO₂ has been found to be an advantageous component in order to obtain the desired amorphous phase. In particular, the proportion by weight in the lithium ion-conducting material of SiO₂ is greater than the proportion by weight of B₂O₃ in the lithium ion-conducting material. Preferably, the ratio of the proportion by weight of B₂O₃ in the lithium ion-conducting material to the proportion by weight of SiO₂ in the lithium ion-conducting material is not more than 0.9, more preferably not more than 0.75, more preferably not more than 0.5, more preferably not more than 0.25, more preferably not more than 0.1, more preferably not more than 0.05, more preferably not more than 0.01.

The sum total of the proportions by weight of SiO₂ and B₂O₃ based on the total mass of the lithium ion-conducting material is preferably at least 0.1% by weight, more preferably at least 0.2% by weight, more preferably at least 0.3% by weight, more preferably at least 0.4% by weight, more preferably at least 0.5% by weight, more preferably at least 0.6% by weight, more preferably at least 0.7% by weight. The sum total of the proportions by weight of SiO₂ and B₂O₃, based on the total mass of the lithium ion-conducting material, is, for example, not more than 5.0% by weight, in particular not more than 4.5% by weight, not more than 4.0% by weight, not more than 3.5% by weight, not more than 3.0% by weight, not more than 2.5% by weight, or not more than 2.0% by weight. The sum total of the proportions by weight of SiO₂ and B₂O₃, based on the total mass of the lithium ion-conducting material is, for example, 0.1% to 5.0% by weight, in particular 0.2% to 4.5% by weight, 0.3% to 4.0% by weight, 0.4% to 3.5% by weight, 0.5% to 3.0% by weight, 0.6% to 2.5% by weight, or 0.7% to 2.0% by weight.

The proportion by weight of SiO₂ based on the total mass of the lithium ion-conducting material is preferably at least 0.1% by weight, more preferably at least 0.2% by weight, more preferably at least 0.3% by weight, more preferably at least 0.4% by weight, more preferably at least 0.5% by weight, more preferably at least 0.6% by weight, more preferably at least 0.7% by weight. The proportion by weight of SiO₂ based on the total mass of the lithium ion-conducting material is, for example, not more than 5.0% by weight, in particular not more than 4.5% by weight, not more than 4.0% by weight, not more than 3.5% by weight, not more than 3.0% by weight, not more than 2.5% by weight, or not more than 2.0% by weight. The proportion by weight of SiO₂, based on the total mass of the lithium ion-conducting material, is, for example, 0.1% to 5.0% by weight, in particular 0.2% to 4.5% by weight, 0.3% to 4.0% by weight, 0.4% to 3.5% by weight, 0.5% to 3.0% by weight, 0.6% to 2.5% by weight or 0.7% to 2.0% by weight.

As described above, SiO₂ is assigned to the amorphous phase as a glass former. Thus, if the lithium ion-conducting material contains, for example, 0.5% by weight of SiO₂, this 0.5% by weight is assigned to the amorphous phase. As likewise described above, excess Li₂O is assigned to the amorphous phase. The proportion in the amorphous phase of the lithium ion-conducting material corresponds in particular to the sum total of the proportion of Li₂O in the amorphous phase (based on the total mass of the lithium ion-conducting material) and the proportion of at least one glass former in the amorphous phase (based on the total mass of the lithium ion-conducting material).

The amorphous phase could consist, for example, of 2.0% by weight Li₂O (based on the total mass of the lithium ion-containing material) and 0.5% by weight SiO₂ (based on the total mass of the lithium ion-containing material). The proportion in the amorphous phase of the lithium ion-conducting material in this case would be 2.5% by weight (2.0% by weight of Li₂O+0.5% by weight of SiO₂). The proportion by weight of SiO₂ based on the total weight of the amorphous phase would be 20% by weight (0.5% by weight of SiO₂ divided by the 2.5% by weight of the total amorphous phase). Conversely, the proportion by weight of Li₂O based on the total weight of the amorphous phase would be 80% by weight.

Preferably, the proportion by weight of SiO₂ based on the total weight of the amorphous phase is at least 1.0% by weight, more preferably at least 2.0% by weight, more preferably at least 5.0% by weight, more preferably at least 7.5% by weight, more preferably at least 10.0% by weight, more preferably at least 12.5% by weight. SiO₂ is advantageous for stabilization of the amorphous phase. However, it is advantageous not to choose an excessively high SiO₂ content with regard to a particularly high Li ion conductivity. Preferably, the proportion by weight of SiO₂ based on the total weight of the amorphous phase is not more than 60.0% by weight, more preferably not more than 55.0% by weight, more preferably not more than 50.0% by weight, more preferably not more than 45.0% by weight, more preferably not more than 40.0% by weight, more preferably not more than 35% by weight. Preferably, the proportion by weight of SiO₂ based on the total weight of the amorphous phase is within a range from 1.0% to 60.0% by weight, more preferably from 2.0% to 55.0% by weight, more preferably from 5.0% to 50.0% by weight, more preferably from 7.5% to 45.0% by weight, more preferably from 10.0% to 40.0% by weight, more preferably from 12.5% to 35.0% by weight.

Preferably, the proportion by weight of Li₂O based on the total weight of the amorphous phase is at least 40.0% by weight, more preferably at least 45.0% by weight, more preferably at least 50.0% by weight, more preferably at least 55.0% by weight, more preferably at least 60.0% by weight, more preferably at least 65.0% by weight. Li₂O is advantageous for Li ion conductivity. However, it is advantageous not to choose an excessively high Li₂O content with regard to a particularly stable amorphous phase. Preferably, the proportion by weight of Li₂O based on the total weight of the amorphous phase is not more than 99.0% by weight, more preferably not more than 98.0% by weight, more preferably not more than 95.0% by weight, more preferably not more than 92.5% by weight, more preferably not more than 90.0% by weight, more preferably not more than 87.5% by weight. Preferably, the proportion by weight of Li₂O based on the total weight of the amorphous phase is within a range from 40.0% to 99.0% by weight, more preferably from 45.0% to 99.0% by weight, more preferably from 50.0% to 95.0% by weight, more preferably from 55.0% to 92.5% by weight, more preferably from 60.0% to 90.0% by weight, more preferably from 65.0% to 87.5% by weight.

Preferably, the lithium ion-conducting material contains only very small amounts of B₂O₃, if any. It has been found that B₂O₃ leads to an increase in interfacial resistances. The lithium ion-conducting material therefore preferably has a B₂O₃ content of less than 0.4% by weight, in particular not more than 0.3% by weight, not more than 0.2% by weight or not more than 0.1% by weight. More preferably, the lithium ion-conducting material of the invention is free of B₂O₃.

When the present disclosure states that the material is free of a component or does not contain a component, what this means is that said component may at most be present as an impurity. This means that it is not added in significant amounts. According to the invention, non-significant amounts are amounts of not more than 0.05% by weight or not more than 0.04% by weight.

The lithium ion-conducting material comprises a crystalline phase and an amorphous phase. The crystalline phase may include a main crystal phase. The main crystal phase is that crystal phase which has the highest percentage by weight of the crystalline phase in the lithium ion-conducting material. The main crystal phase in particular has a proportion of at least 50% by weight of the crystalline phase of the lithium ion-conducting material, for example more than 50% by weight, at least 60% by weight, at least 70% by weight, at least 80% by weight, at least 90% by weight, at least 95% by weight, or even 100%. The crystalline phase of the lithium ion-conducting material may thus consist of the main crystal phase.

The main crystal phase may in particular have a garnet structure. The main crystal phase may also have a rock salt structure, a perovskite structure, an anti-perovskite structure or a NASICON structure. The main crystal phase may be in the cubic crystal system, for example. For example, the main crystal phase may include or consist of lithium lanthanum zirconate (LLZO).

The main crystal phase of the crystalline phase of the lithium ion-conducting material may in particular have the empirical formula Li_{7-3x+y-z}Alₓ M_{y}^{II} M_{3-y}^{III}M_{2-z}^{IV}M_{z}^{V}O_{12±δ}; where M^{II} comprises one or more divalent cations, M^{III} comprises one or more trivalent cations, M^{IV} comprises one or more tetravalent cations and M^{V} comprises one or more pentavalent cations, where x+z>0, y<1 and 0<0.5. More preferably, M^{III} comprises one or more lanthanides and/or yttrium. More preferably, M^{IV} comprises zirconium or hafnium. More preferably, M^{V} comprises niobium or tantalum. More preferably, M^{III} comprises one or more lanthanides and/or yttrium, M^{IV} comprises zirconium or hafnium, and M^{V} comprises niobium or tantalum.

The lithium ion-conducting material comprises a crystalline phase and an amorphous phase. The crystalline phase may be present in the lithium ion-conducting material, for example, in the form of crystallites separated by grain boundaries. The amorphous phase may be present in particular in the grain boundaries. For example, the amorphous phase may have a density of at least 1.5 g/cm³.

The invention relates to a solid electrolyte comprising or consisting of the lithium ion-conducting material. The solid electrolyte is in particular a sintered molding. The solid electrolyte is preferably an inorganic solid electrolyte.

The solid electrolyte has a relative density of at least 90%, more preferably at least 91%, more preferably at least 92%, more preferably at least 93%, more preferably at least 94%, more preferably at least 95%. The relative density of the solid electrolyte may, for example, be not more than 100%, in particular not more than 99.9%, not more than 99.5%, not more than 99.0%, not more than 98.5% or not more than 98.0%. The relative density of the solid electrolyte is preferably within a range from 90% to 100%, for example 91% to 99.9%, 92% to 99.5%, 93% to 99.0%, 94% to 98.5%, or 95% to 98.0%.

The solid electrolyte has such a microstructure that less than 10% of the cross-sectional area of the solid electrolyte is accounted for by grains with a diameter of more than 30 μm. The solid electrolyte thus has a fine-grain microstructure.

Preferably not more than 9%, further preferably not more than 8%, more preferably not more than 7%, more preferably not more than 6%, more preferably not more than 5%, of the cross-sectional area of the solid electrolyte is accounted for by grains with a diameter of more than 30 μm. In some embodiments, at least 0.01%, for example at least 0.02%, at least 0.05%, at least 0.1%, at least 0.2%, at least 0.5% or at least 1% of the cross-sectional area of the solid electrolyte is accounted for by grains with a diameter exceeding 30 μm. In some embodiments, 0.01% to <10%, for example 0.02% to 9%, 0.05% to 8%, 0.1% to 7%, 0.2% to 6%, 0.5% to 5% or 1% to 5% of the cross-sectional area of the solid electrolyte is accounted for by grains with a diameter of more than 30 μm.

Preferably, less than 10% of the cross-sectional area of the solid electrolyte is accounted for by grains with a diameter of at least 25 μm, more preferably at least 20 μm, more preferably at least 15 μm, more preferably at least 10 μm.

Preferably at least 90% of the cross-sectional area of the solid electrolyte is accounted for by grains with a diameter of not more than 30 μm, more preferably not more than 25 μm, more preferably not more than 20 μm, more preferably not more than 15 μm, more preferably not more than 10 μm. Preferably, at least 90% of the cross-sectional area of the solid electrolyte is accounted for by grains with a diameter within a range from 0.1 to 30 μm, for example from 0.1 to 25 μm, from 0.2 to 20 μm, from 0.2 to 15 μm, or from 0.5 to 10 μm.

Preferably at least 91%, more preferably at least 92%, more preferably at least 93%, more preferably at least 94%, more preferably at least 95% of the cross-sectional area of the solid electrolyte is accounted for by grains with a diameter of not more than 30 μm. In some embodiments, not more than 99.99%, for example not more than 99.98%, not more than 99.95%, not more than 99.9%, not more than 99.8%, not more than 99.5% or not more than 99% of the cross-sectional area of the solid electrolyte is accounted for by grains with a diameter not more than 30 μm. In some embodiments, 90% to 99.99%, for example 91% to 99.98%, 92% to 99.95%, 93% to 99.9%, 94% to 99.8%, 95% to 99.5% or 95% to 99%, of the cross-sectional area of the solid electrolyte is accounted for by grains with a diameter not more than 30 μm.

The microstructure is analyzed as follows:

Samples of the sintered solid electrolytes with a diameter of 8.5 mm and a height of 1 mm are penetrated by means of a diamond glass cutter. The resulting fracture edge is examined by scanning electron microscopy (SEM). The SEM images obtained thus provide a top view of the fracture edge. The fracture edge in turn serves to examine the cross-sectional face of the solid electrolyte.

For scanning electron microscopy, in particular a ZEISS LEO1550 with a field emission source can be used to generate the corresponding SEM images with a secondary electron detector at an acceleration voltage of 10-20 keV. The magnification is preferably 500x or 1000x.

The SEM images obtained are used to determine the microstructure of the sintered solid electrolytes. For this purpose, images with an area of at least 0.04 mm² are evaluated. A number of 2 images are evaluated for each of the samples.

According to the present disclosure, a distinction is made between fine-grain and coarse-grain microstructures. The microstructure is coarse-grain if larger particles (>30 μm) account for at least 10% of the area of the fracture edge. A fine-grain microstructure, by contrast, is one in which larger particles (>30 μm) account for less than 10% of the area of the fracture edge. The terms “particle” and “grain” are used synonymously in the present disclosure, unless stated otherwise. The “size” of the particles means the diameter of the grains, and therefore the above-described maximum Feret diameter (Feret-max), i.e. the maximum distance between two parallel tangents to the contour of the grain in the examined cross-sectional area of the solid electrolyte.

In the case of a fine-grain microstructure, at least 90% of the area of the fracture edge of the solid electrolyte is correspondingly composed of particles with a size of not more than 30 μm, in particular with a size within a range from 0.1 μm to 30 μm. Larger particles (>30 μm) account for less than 10% of the area of the fracture edge. In the case of a coarse-grain microstructure, less than 90% of the area of the fracture edge of the solid electrolyte consists of particles with a size of not more than 30 μm, in particular with a size within a range from 0.1 μm to 30 μm. Larger particles (>30 μm) account for at least 10% of the area of the fracture edge.

The analysis takes place in each case on the SEM images of the fracture edge. If larger particles (>30 μm) account for at least 10% of the area of the images examined, this is correspondingly also applicable to the area of the fracture edge and hence to the cross-sectional area of the solid electrolyte. The microstructure is coarse-grain. If larger particles (>30 μm) account for less than 10% of the area of the images examined, this is correspondingly also applicable to the area of the fracture edge and hence to the cross-sectional area of the solid electrolyte. The microstructure is fine-grain.

The invention also relates to a method of producing a solid electrolyte, in particular the solid electrolyte of the present invention.

The procedure may in particular comprise the following steps:
melting the starting materials,
cooling the melt,
grinding the material obtained to a powder having a particle size d₅₀ within a range from 0.1 μm to 10 μm,
producing an intermediate product comprising the powder or consisting of the powder, and
sintering the intermediate product, the sintering temperature being in particular not more than 1100° C.

The sintering of the intermediate product affords the solid electrolyte.

The producing of the intermediate product may be, for example, the pressing of the powder to a compact. The intermediate product may therefore be a compact.

The procedure may in particular comprise the following steps:
melting the starting materials,
cooling the melt,
grinding the material obtained to a powder having a particle size d₅₀ within a range from 0.1 μm to 10 μm,
pressing the powder to a compact, and
sintering the compact, the sintering temperature being in particular not more than 1100° C.

The sintering of the compact affords the solid electrolyte.

The method of the present invention may also be a tape casting method. In this case, the intermediate product is not produced by pressing the powder to a compact. Instead, the intermediate product is produced by processing the powder to a tape (also called “foil” or “green foil”). The processing of the powder to a tape preferably comprises the following steps:
mixing the powder with one or more solvents and one or more organic binders, and optionally plasticizers and/or other additives for producing a slip (also called “slurry”),
optionally deaerating the slip,
casting the slip to a film (also called “tape”) on a support base,
removing the solvents from the tape by evaporation,
detaching the tape from the support base,
optionally, separately cutting the tape to an application-specific format,
optionally, hot pressing or laminating one or more layers of tapes at temperatures between 40 and 200° C.,
removing the organic binders, and also the optionally present plasticizers and further additives, and any solvent residues from the tape or laminate by thermal treatment at a temperature of 250° C. to 500° C.

Sintering of the tape then affords the solid electrolyte. In the tape casting process, the intermediate product is thus a tape.

The starting materials (also referred to as raw materials) can be melted, for example, in a skull crucible (especially one which is open at the top). The raw materials are preferably mixed and the resulting blend is preheated. In particular, a burner heater can be used for this purpose. The preheating can achieve a minimum conductivity. On attainment of what is called the coupling temperature, further heating and homogenization of the melt can be achieved by high-frequency coupling, in particular via an induction coil. In order to improve the homogenization of the melt, the melt can be stirred, especially with a water-cooled stirrer. On completion of homogenization, for example, direct samples can be taken from the melt (rapid cooling), while the rest of the melt can be cooled gradually by switching off the high frequency.

The material produced in this way can be converted either by direct solidification from the melt or by quenching, followed by a thermal treatment (ceramization), to a lithium ion-conducting, in particular glass-ceramic, material with a garnet-like main crystal phase. If the samples taken directly from the melt show spontaneous crystallization irrespective of the cooling, it is possible to dispense with a subsequent ceramization treatment.

The sintering temperature is preferably not more than 1090° C., more preferably not more than 1080° C., more preferably not more than 1070° C., more preferably not more than 1060° C., more preferably not more than 1050° C., more preferably not more than 1040° C., more preferably not more than 1030° C., more preferably not more than 1020° C., more preferably not more than 1010° C., more preferably not more than 1000° C. The sintering temperature may, for example, be at least 850° C., at least 875° C., at least 900° C., at least 925° C., at least 950° C., or at least 975° C. The sintering temperature is preferably within a range from 850° C. to 1100° C., for example from 850° C. to 1090° C., from 850° C. to 1080° C., from 850° C. to 1070° C., from 850° C. to 1060° C., from 850° C. to 1050° C., from 875° C. to 1040° C., from 900° C. to 1030° C., from 925° C. to 1020° C., from 950° C. to 1010° C., or from 975° C. to 1000° C.

The sintering time is preferably not more than 4 hours, more preferably not more than 3 hours, more preferably not more than 2 hours, more preferably not more than 1 hour, more preferably not more than 45 minutes, more preferably not more than 40 minutes. The sintering time is preferably at least 5 minutes, more preferably at least 10 minutes, more preferably at least 15 minutes, more preferably at least 20 minutes, more preferably at least 25 minutes, more preferably at least 30 minutes. The sintering time is preferably within a range from 5 minutes to 4 hours, for example from 10 minutes to 3 hours, from 15 minutes to 2 hours, from 20 minutes to 1 hour, from 25 minutes to 45 minutes, or from 30 minutes to 40 minutes.

The invention also relates to a tape casting method of producing a solid electrolyte, in particular the solid electrolyte of the present invention. The procedure may in particular comprise the following steps:
melting the starting materials,
cooling the melt,
grinding the material obtained to a powder having a particle size d₅₀ within a range from 0.1 μm to 10 μm,
mixing the powder with one or more solvents and one or more organic binders, and optionally plasticizers and/or other additives (for example dispersing additives and/or rheology additives) for producing a slip (also called “slurry”),
optionally deaerating the slip,
casting the slip to a film (also called “tape”) on a support base,
removing the solvents from the tape by evaporation,
detaching the tape from the support base,
optionally, separately cutting the tape to an application-specific format,
optionally, hot pressing or laminating one or more layers of tapes at temperatures between 4° and 200° C.,
removing the organic binders, and also the optionally present plasticizers and further additives, and any solvent residues from the tape or laminate by thermal treatment at a temperature of 250° C. to 500° C.,
sintering the tape, the sintering temperature being not more than 1100° C.

The invention also relates to the use of the solid electrolyte of the invention in solid-state lithium-ion batteries, in particular in or as a separator. The lithium ion-conducting material can also be used in the anode and/or cathode, especially after co-sintering with the electrode materials.

The solid electrolyte can in particular be used in rechargeable lithium-ion batteries, especially in all-solid-state batteries (ASSB), on its own or sintered together with other battery materials to give an inorganic ceramic electrolyte. Firstly, use as a separator is conceivable: inserted between the electrodes, it protects these from an unwanted short circuit and hence ensures the functionality of the entire system. A particular feature of the separator of the invention is improved dendrite stability, which allows charging with higher current density without a short circuit (fast charging). Secondly, co-sintering with the electrode materials is conceivable: in this case, the solid-state electrolyte accomplishes the transport of the relevant charge carriers (lithium ions) to and from the electrode materials and the conductive electrodes, depending on whether the battery is being discharged or charged.

The terms “solid electrolyte” and “solid-state electrolyte” are used synonymously in the present disclosure, unless stated otherwise.

The invention also relates to a separator comprising or consisting of a solid electrolyte of the invention.

The present invention also relates to solid-state lithium-ion batteries comprising the solid electrolyte of the invention.

### BRIEF DESCRIPTION OF THE FIGURES

FIG. 1 shows the dependence of the relative density in the course of sintering for 30 minutes at a sintering temperature of 1000° C. on the size of the endothermic DSC signal in the range from 850° C. to 1100° C. The size of the endothermic DSC signal is given in J/g on the x axis. The reading at 0 J/g indicates that there was no endothermic DSC signal in the range from 850° C. to 1100° C. The y axis gives the relative density in percent.

### EXAMPLES

The examples elucidated hereinafter relate to three inventive LLZO glass ceramics (examples A, B and C) and one noninventive LLZO glass ceramic (comparative example V1).

### 1. Production of LLZO Glass Ceramics

The raw materials were mixed in accordance with the compositions and filled into a skull crucible that was open at the top. The mixture first had to be preheated to achieve a certain minimum conductivity. A burner heater was used for this purpose. On attainment of the coupling temperature, further heating and homogenization of the melt was achieved by high-frequency coupling via an induction coil. In order to improve the homogenization of the melts, they were stirred with a water-cooled stirrer. On completion of homogenization, direct samples were taken from the melt (rapid cooling), while the rest of the melt was slowly cooled down by switching off the high frequency.

The material produced in this way can be converted either by direct solidification from the melt or by quenching, followed by a thermal treatment (ceramization), to a glass-ceramic material with a garnet-like main crystal phase. The samples taken directly from the melt showed spontaneous crystallization irrespective of the cooling, and so it was possible to dispense with a subsequent ceramization treatment.

### 2. Compaction Point of the Amorphous Phase

Samples of examples A, B and C and of comparative example V1 were each analyzed by differential scanning calorimetry (DSC). The experiment was conducted as follows: Samples (20-100 mg) of the LLZO glass ceramics obtained in point 1 were placed in a platinum DSC crucible. The DSC analysis was performed at a heating rate of 10 K/min under argon from room temperature to at least 1100° C. The DSC signal was determined with a heat-flow DSC, using the Pegasus® DSC 404 F1 instrument from NETZSCH-Gerätebau GmbH.

In the inventive examples A, B and C, an endothermic signal of more than 10 J/g was detected in the range from 850° C. to 1100° C. By contrast, in comparative example V1, there is no endothermic signal of the same magnitude. The results are summarized in the table that follows.

TABLE 1

| | Endothermic DSC signal | |
|---|---|---|
| | Peak | |
| Examples | position | Peak height |
| Comp. ex. | — | 0 |
| V1 | | |
| Ex. A | 1002° C. | 20 J/g |
| Ex. B | 962° C. | 21 J/g |
| Ex. C | 1030° C. | 51 J/g |

Inventive examples A, B and C are thus distinctly different than comparative example V1 with regard to the occurrence of an endothermic signal in the range from 850° C. to 1100° C. The amorphous phase of examples A, B and C has a compaction point within a range from 850° C. to 1100° C. The amorphous phase of comparative example V1, on the other hand, has no compaction point in the range from 850° C. to 1100° C.

### 3. Microstructure and Relative Density of the Sintered Solid Electrolytes

Samples of the LLZO glass ceramics of examples A, B and C and of comparative example V1 were ground to a size of d₅₀=1 μm, then pressed to compacts and sintered to solid electrolytes at a sintering temperature of 1000° C. for 30 minutes.

For comparative purposes, samples of the LLZO glass ceramics from example A and comparative example V1 were ground to a size of d₅₀=1 μm, then pressed to compacts and sintered to solid electrolytes at a sintering temperature of 1130° C. for 30 minutes.

For comparative purposes, the samples of the LLZO glass ceramic from example B were ground to a size of d₅₀=1 μm, then pressed to compacts, and these were sintered to solid electrolytes at a sintering temperature of 1070° C. for 30 minutes.

### a) Microstructure

Based on all four LLZO glass ceramics (A, B, C, V1), sintered solid electrolytes with a fine-grain microstructure were obtained at a sintering temperature of 1000° C. By contrast, the microstructure at a sintering temperature of 1130° C. was not fine-grain in comparative example V1 or even in example A. Large domains occurred. In example B, the microstructure was fine-grain at the sintering temperatures of 1000° C. and 1070° C.

The microstructure was analyzed as follows:

samples of the LLZO glass ceramics with a diameter of 8.5 mm and a height of 1 mm were penetrated by means of a diamond glass cutter. The resulting fracture edge was examined by scanning electron microscopy (SEM). The SEM images obtained thus provide an top view of the fracture edge. The fracture edge in turn served to examine the cross-sectional face of the solid electrolyte.

For scanning electron microscopy, a ZEISS LEO1550 with a field emission source was used to generate the corresponding SEM images with a secondary electron detector at an acceleration voltage of 10-20 keV. The magnification was 500x or 1000x.

The SEM images obtained were used to determine the microstructure of the sintered solid electrolytes. For this purpose, images with an area of at least 0.04 mm² were evaluated. Two images were evaluated for each of the samples.

Based on all four LLZO glass ceramics (A, B, C, V1), in the present case, sintered solid electrolytes with a fine-grain microstructure were obtained at a sintering temperature of 1000° C. Larger particles (>30 μm) each accounted for less than 10% of the area of the images examined.

By contrast, the microstructure at a sintering temperature of 1130° C. was coarse-grain in comparative example V1 and even in example A. Larger particles (>30 μm) each accounted for at least 10% of the area of the images examined.

The desired fine-grain microstructure was thus achieved at a sintering time of 30 minutes with a sintering temperature of 1000° C., but not with a sintering temperature of 1130° C.

In example B, the desired fine-grain microstructure was achieved at a sintering temperature of 1000° C. and also of 1070° C.

### b) Relative Density

The sintered solid electrolytes were examined for their relative density. Relative density was determined as follows:

He pycnometry was used to determine the density of the powder. After sintering, the density of the solid electrolyte was determined by weighing and geometric measurement (density=mass per unit volume). The relative density is the quotient of the density of the solid electrolyte and density of the powder.

As expected, the solid electrolytes according to example A and comparative example V1, which were sintered at 1130° C. for 30 minutes, gave high relative densities of 96% (Ex. A) or 91% (comparative example V1). However, the corresponding solid electrolytes did not have the desired fine-grain microstructure as described above.

For the solid electrolytes sintered at 1000° C., large differences were found with regard to relative density depending on the shape of the endothermic DSC signal in the range from 850° C. to 1100° C.

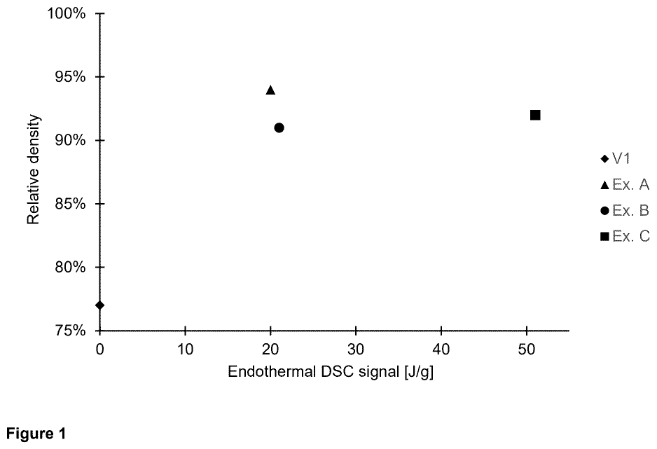

The results are shown in FIG. 1 and summarized in table 2 below.

TABLE 2

| | Sintering conditions | | | | | |
|---|---|---|---|---|---|---|
| | 1000° C.; 30 min | | 1070° C.; 30 min | | 1130° C.; 30 min | |
| | Relative | | Relative | | Relative | |
| Examples | density | Microstructure | density | Microstructure | density | Microstructure |
| Comp. | 77% | fine-grain | | | 91% | coarse- |
| ex. V1 | | | | | | grain |
| Ex. A | 94% | fine-grain | | | 96% | coarse- |
| | | | | | | grain |
| Ex. B | 91% | fine-grain | 96% | fine-grain | | |
| Ex. C | 92% | fine-grain | | | | |

A clear dependence of the relative density on the presence of the endothermic DSC signal is shown. If no such signal is present (comparative example V1), comparatively low relative densities are obtained. By contrast, with a pronounced endothermic DSC signal of more than 10 J/g (examples A, B and C), sintered solid electrolytes having high relative densities of more than 90% are obtained even in the case of a sintering temperature of only 1000° C. and a sintering time of only 30 minutes.

What is claimed is:

1-17. (canceled)

18. A solid electrolyte comprising:
a lithium ion-conducting material, the lithium ion-conducting material including a crystalline phase and an amorphous phase, the crystalline phase including a main crystal phase, main crystal phase having a proportion of the crystalline phase of at least 50% by weight, a relative density of the solid electrolyte being at least 90% and the solid electrolyte having a microstructure where less than 10% of the cross-sectional area of the solid electrolyte is accounted for by grains with a diameter of more than 30 μm.

19. The solid electrolyte as recited in claim 18 wherein the lithium ion-conducting material is a glass ceramic.

20. The solid electrolyte as recited in claim 18 wherein the main crystal phase is in the cubic crystal system or has a garnet structure.

21. The solid electrolyte as recited in claim 18 wherein the main crystal phase comprises lithium lanthanum zirconate (LLZO).

22. The solid electrolyte as recited in claim 18 wherein the main crystal phase has the empirical formula Li_{7-3x+y-z}AlₓM_{y}^{II} M_{3-y}^{III} M_{2-z}^{IV} M_{z}^{V} O_{12±δ} where M^{II} comprises one or more divalent cations, M^{III} comprises one or more trivalent cations, M^{IV} comprises one or more tetravalent cations and M comprises one or more pentavalent cations, where x+z>0, y<1 and δ<0.5.

23. The solid electrolyte as recited in claim 18 wherein the amorphous phase comprises Li₂O and wherein the proportion of the amorphous phase in the lithium ion-conducting material is at least 0.1% by weight.

24. The solid electrolyte as recited in claim 18 wherein the amorphous phase has a compaction point within a range from 850° C. to 1100° C.

25. The solid electrolyte as recited in claim 18 wherein a sum total of the proportions by weight of SiO₂ and B₂O₃ based on the total mass of the lithium ion-conducting material is at least 0.1% by weight and wherein the proportion by weight of SiO₂ is greater than the proportion by weight of B₂O₃.

26. The solid electrolyte as recited in claim 18 wherein the lithium ion-conducting material has a proportion of B₂O₃ of not more than 0.1% by weight.

27. The solid electrolyte as recited in claim 18 wherein the lithium ion-conducting material has a proportion of SiO₂ of at least 0.1% by weight.

28. The solid electrolyte as recited in claim 18 wherein the proportion by weight of SiO₂ based on the total weight of the amorphous phase is within a range from 1.0% to 60.0% by weight.

29. A method of producing a solid electrolyte as recited in claim 18, the method comprising the following steps:
melting starting materials to define a melt;
cooling the melt to define a cooled material;
grinding the cooled material to a powder having a particle size d₅₀ within a range from 0.1 to 10 μm,
producing an intermediate product comprising the powder, and
sintering the intermediate product, the sintering temperature being not more than 1100° C.

30. The method as recited in claim 29 wherein the intermediate product consists of the powder.

31. The method as recited in claim 29 wherein the producing of the intermediate product includes the pressing of the powder to a compact.

32. The method as recited in claim 29 wherein the intermediate product is produced by processing the powder to a tape, where the processing of the powder to a tape comprises the following steps:
mixing the powder with one or more solvents and one or more organic binders to produce a slip;
casting the slip to a tape on a support base,
removing the solvents from the tape by evaporation,
detaching the tape from the support base, and
removing the organic binders and any solvent residues from the tape by thermal treatment at a temperature of 250° C. to 500° C.

33. The method as recited in claim 29 wherein the sintering time is not more than 4 hours.

34. A method comprising:
employing of solid electrolyte as recited in claim 18 in a solid-state lithium-ion battery.

35. The method as recited in claim 34 wherein the solid electrolyte is employed in or as a separator.

36. A separator comprising the solid electrolyte as recited in claim 18.
